(19) United States
(12) Patent Application Publication
(10) Pub. No.: US 2016/0061456 A1
(43) Pub. Date: Mar. 3, 2016

(54) PORTABLE BURNER

(71) Applicant: INDONG CHEOLMOOL GONGGU SANGSA CO., LTD., Sejong (KR)

(72) Inventor: Seong Geun Jang, Sejong (KR)

(21) Appl. No.: 14/720,896

(22) Filed: May 25, 2015

(30) Foreign Application Priority Data
Aug. 29, 2014 (KR) 10-2014-0114115

(51) Int. Cl. F24C 5/04; A47J 37/07; F24C 5/20

(52) U.S. Cl. CPC F24C 5/04; F24C 5/20; A47J 37/0763

(57) ABSTRACT

The present invention relates to a portable burner in which a combustion gas exhaust path formed by a case body including an external case and an internal case and by a camping cooker inserted into the case body is formed in zigzag, and combustion gas is not immediately exhausted to achieve heat exchange for a sufficient time, thereby improving thermal efficiency and safely carrying the portable burner.

### CROSS-REFERENCE TO RELATED APPLICATION

This application claims priority to and the benefit of Korean Patent Application No. 10-2014-0114115, filed on Aug. 29, 2014, the disclosure of which is incorporated herein by reference in its entirety.

### BACKGROUND

1. Field of the Invention

The present invention relates to a portable burner, and more particularly, to a portable burner in which a combustion gas exhaust path formed by a case body including an external case and an internal case and by a camping cooker inserted into the case body is formed in zigzag, and combustion gas is not immediately exhausted to achieve heat exchange for a sufficient time, thereby improving thermal efficiency and safely carrying the portable burner.

2. Description of the Related Art

Generally, burners and camping cookers have been widely used as tools for cooking in mountaineering, fishing, picnic, and the like.

However, since a burner and a camping cooker of the related art are separately provided, there is inconvenience of separately preparing and carrying the burner and the camping cooker, preheating is necessary at the time of ignition when using an oil burner, the ignition is difficult and there is difficulty particularly in windy environment, a unskilled user is not familiar with how to use, and there are many conveniences.

Accordingly, an alcohol burner may be used instead of the oil burner inconvenient in using, the alcohol burner has heat lower than that of the oil burner and has difficulty in cooking and has inconvenience. For example, a windbreak needs to be additionally used when cooking outdoor particularly since it is weak against wind, and rice on the bottom of the camping cooker is burned while rice on the top is not well done, which are the difficulties.

In addition, in a case of the oil burner or alcohol burner, flame of the burner is directly exposed to the outside, and there is a problem of being weak against fire when there is a flammable material in the vicinity thereof.

As a related art to solve such problems, Korean Registered Utility Model No. 20-0030358 (Registration Date: Feb. 21, 1986) is disclosed, and FIG. 1 is a cross-sectional view illustrating the use of the related art, which includes a rice-cooker 7 that has a lid 2 and an outer tube 9 provided with a hook projection 17 and an exhaust hole 16, an air supply port 11, a pedestal 6 that is provided with a protrusion groove 10 coupled with an alcohol tube 5 and a base projection 18 coupled with the outer tube 9, and the alcohol tube 5 that is provided with a protruding hook projection 15, wherein when alcohol is put in the alcohol tube 5 and ignition is performed, the alcohol flame is exhausted from the exhaust hole 16 through a space between the outer tube 9 and the small rice-cooker 7, there is no influence based on wind from the outside, there is no contact with cold air by the outer tube 9, and heat loss is less.

However, the related art has a large volume in structure, keeping and carrying are not easy, there is a great problem that heat loss is large due to limitation of directly transferring the heat to the outer tube and immediately emitting the heat to the upper side, the surface of the outer tube is hot, there is a very large worry of getting burned during using, and it is exposed to the risk of fire particularly when there is a flammable material in the vicinity thereof.

### SUMMARY

The invention has be designed to solve the problems of the related art, and an object of the invention is to provide a portable burner having a thermal insulation function between an outer case exposed to the outside and an inner case provided in the outer case, to minimize heat emitted to the outside, to improve thermal efficiency, to prevent a burn, to minimize ignition possibility at the time of being close to a flammable material, thereby further safely using the portable burner.

Another object of the present invention is to provide a portable burner in that a appearance standard is minimized through the close structural combination of a camping cooker and a burner, so that the carrying and storage are facilitated; and a discharge path of the combustion gas is formed in zigzags through a combustion gas guide wall of multi-stage installed at the inner wall surface of the inner case so at to contacts with the camping cooker, so that the heat exchange time is adequately satisfied and the heat loss is decreased, thereby improving the heat efficiency.

Further another object of the present invention is to provide a portable burner in that the exterior surface of the camping cooker is generally heated, so that the heating of the camping cooker is easily made and the consumption of fuel is minimized during the cooking; and the heat is evenly transferred during the cooking of rice outside, so that the rice is cooked well regardless the location thereof inside the camping cooker, thereby increasing the reliability of the cooking.

Further another object of the present invention is to provide a portable burner in that it is ignited in a status that the camping cooker is removed and the top of the heater is covered on the upper portion of the outer case, so that the burner can be used for the heater, thereby increasing the generality thereof.

A portable burner according to the invention to solve the problems includes: a fuel tank that is provided with a wick tube including a wick and a wick center support thereon and into which liquid fuel is injected; an inner case that is provided above the fuel tank, is integrally provided with combustion gas guide walls having a multi-layer structure on an inner peripheral face, and is punched with combustion gas exhaust holes A on one upper side; an outer case that is provided to surround at a regular interval on the outside of the fuel tank and the inner case and is punched with combustion gas exhaust holes B at a position corresponding to the combustion gas exhaust holes A; a heat-resistant insulation material that is provided in a space formed between the inner case and the outer case; and a camping cooker that is inserted into the inner case.

Preferably, the portable burner further includes a camping cooker that is inserted into the inner case.

Preferably, the combustion gas guide wall comes in close contact with an outer side of the camping cooker inserted into the inner case to form an exhaust pipe, and the exhaust pipe is formed in zigzag.

Preferably, the outer case includes: a camping cooker input port that is formed in a state where an upper portion is opened to insert and mount the camping cooker; a combustion air inlet that is provided at a lower portion; and an opening and closing door that opens and closes the combustion air inlet.

Preferably, the inner case is provided with a block plate on the bottom thereof, the block plate is punched with a wick tube hole for fitting and coupling the wick tube of the fuel tank, and a plurality of air inflow holes are formed around the wick tube hole.

Preferably, a heat-resistant fuel tank insulation material is provided on the fuel tank, and a support is provided to form a spatial portion serving as a conducted heat blocking function and combustion air passage function between the fuel tank insulation material and the block plate.

Preferably, the portable burner further includes a heater lid for covering the camping cooker input port, on the outer case.

### BRIEF DESCRIPTION OF THE DRAWING(S)

The above and other objects, features and advantages of the present invention will be more apparent from the following detailed description taken in conjunction with the accompanying drawings, in which:

FIG. 1 is a cross-sectional view illustrating a use state of a prefabricated camping cooker used as an alcohol burner according to the related art;

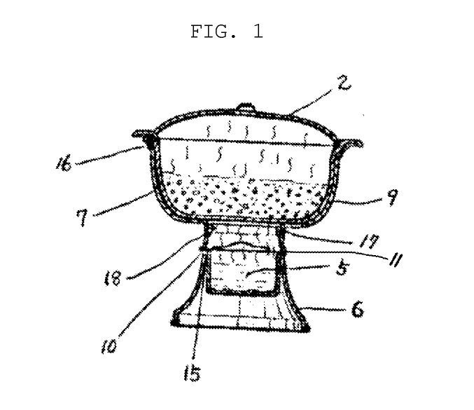

FIG. 2 is a perspective view illustrating a potable burner according to the invention;

FIG. 3 is an exploded perspective view illustrating a potable burner according to the invention;

FIG. 4 is a partial cut-away perspective view illustrating a structure of an inner case of a portable burner according to the invention;

FIG. 5 is a perspective view illustrating a state in which a portable burner according to the invention is also useable as a heater;

FIG. 6 is a cross-sectional view illustrating an operation state of a portable burner according to the invention; and

FIG. 7 is a cross-sectional view illustrating an operation state in which a portable burner according to the invention is used as a simple heater.

### DETAILED DESCRIPTION

Hereinafter, preferred embodiment of the invention will be described in more detail with reference to the accompanying drawings.

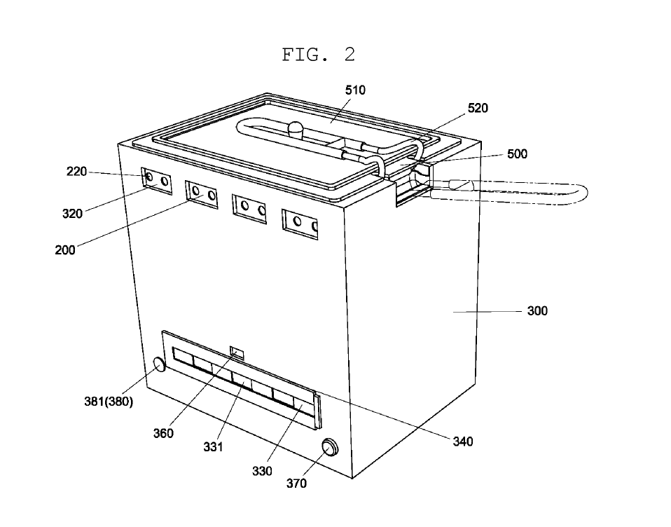

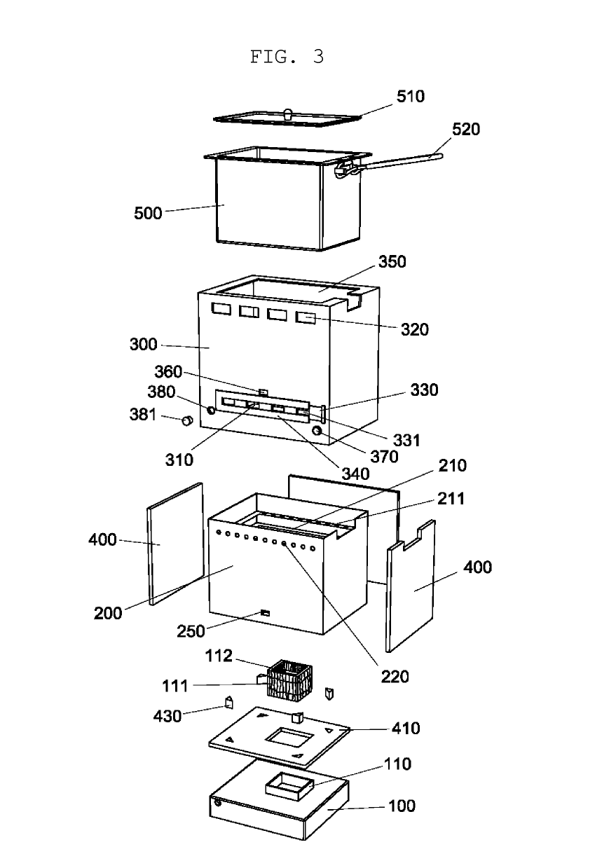

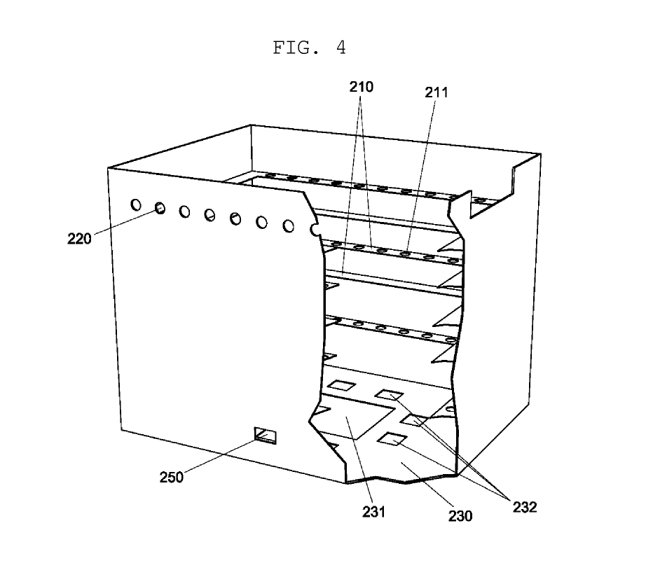

FIG. 2 is a perspective view illustrating a portable burner according to the invention, FIG. 3 is an exploded perspective view illustrating a portable burner according to the invention, and FIG. 4 is a partial cut-away perspective view illustrating a structure of an inner case of a portable burner according to the invention.

The invention includes a burner including a fuel tank 100, an inner case 200, an outer case 300, and an insulation material 400, and includes a camping cooker 500 that can be inserted through the upper portion of the burner in close contact with exhaust gas guide walls 210 having a multi-layer structure provided in the inner case.

The fuel tank 100 is positioned at the lower portion of the burner, a wick tube 110 including a wick 111 and a wick center support 112 is provided on the fuel tank 100, and fuel is continuously supplied into the fuel tank 100 through the wick 111 with liquid fuel injected.

The inner case 200 is provided above the fuel tank 100, combustion gas guide walls 210 having a multi-layer structure are integrally provided in an inner peripheral face thereof in a horizontal direction, and a combustion gas exhaust holes A 220 are formed on one upper side.

In addition, the inner case 200 is provided with a block plate 230 on the bottom, the block plate 230 is punched with a wick tube hole 231 for fitting and coupling the wick tube 110 of the combustion tank 100, and a plurality of air inflow holes 232 are formed around the wick tube hole 231. The air inflow holes are necessary to allow the air for fuel combustion to pass through the airtight burner, and to easily raise the air upward.

The combustion gas guide walls 210 provided in the inner case 200 form an exhaust pipe 240 in close contact with the outer side of the camping cooker 500 inserted therein, and the combustion gas guide walls 210 are punched with exhaust pass holes 211 sequentially in turn for each layer to form the exhaust pipe 240 in zigzag.

According to the invention, in a state of forming the exhaust pipe 240 in a state where the exhaust gas guide walls 210 having the multi-layer structure provided in the inner case 200 come in close contact with the outer side of the camping cooker 500 inserted therein, in order to form the exhaust pipe 240 in zigzag on both left and right sides, the combustion gas guide walls 210 having the multi-layer structure are punched with exhaust pass holes 211 on any one side of left and right of any one layer, the exhaust pass holes 211 are not formed on the other side, the exhaust pass holes of the combustion guide wall 210 of the other layer formed directly on or directly under any one layer are formed in the opposite direction of left or right, and thus heat can be continuously applied to the camping cooker while the combustion gas flows left and right in a space between the inner case and the camping cooker and raises upward.

In other words, the exhaust pipe 240 is formed by the inner case 200, the combustion gas guide walls 210 provided stepwise in the multi-layer structure in the horizontal direction on the inner wall face of the inner case 200, and the exhaust pass holes 211 sequentially formed on the combustion guide walls 210, the heat generated in a combustion chamber sequentially moves left and right along the exhaust pipe 240 to continuously transfer the sufficient heat to the outer wall face of the camping cooker 500, thus thermal efficiency is maximized, a cooking time is saved, and fuel consumption is saved.

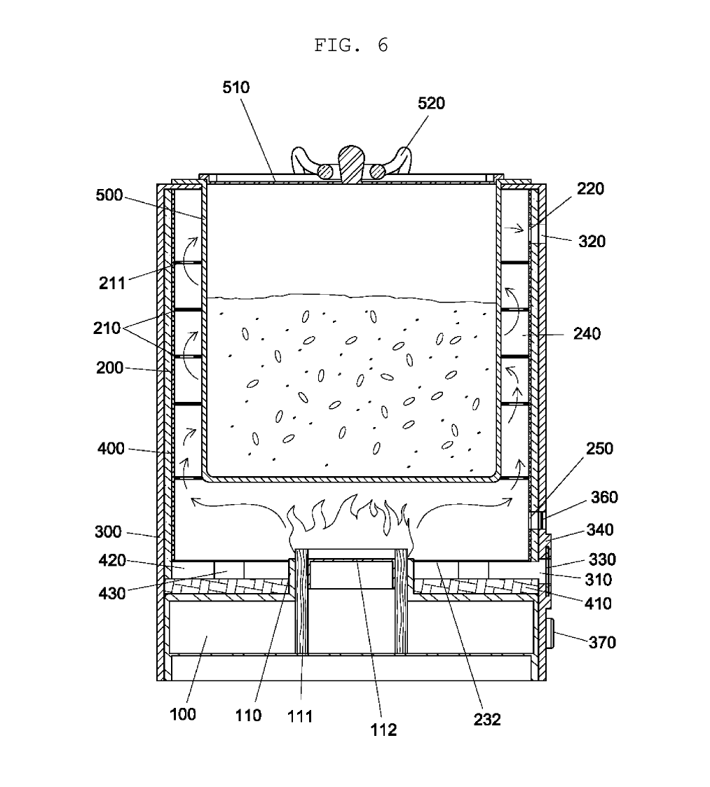

FIG. 6 is a cross-sectional view illustrating an operation state of the portable burner according to the invention, from which it can be seen that the heat generated in the combustion chamber also moves in zigzag left and right and is raised through the structure in which the exhaust pass holes are formed in zigzag left and right for each layer on the combustion gas guide walls, the combustion gas guide walls formed back and forth are not provided with the exhaust pass holes, and the combustion gas moves left or right and moves upward through the outer face of the camping cooker, the front and rear combustion gas guide walls, and the inner face of the inner case.

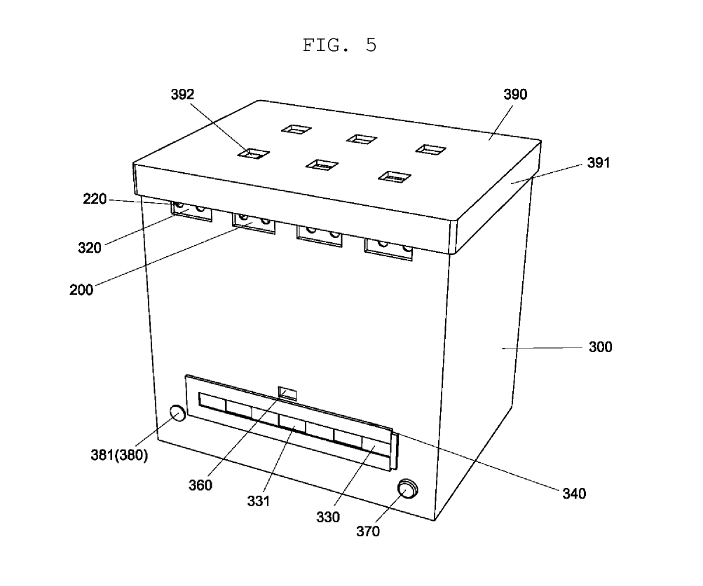

The outer case 300 according to the invention may include a camping cooker input port 350 that is formed to be open at the upper portion such that the camping cooker 500 is inserted and mounted therein, a combustion air inlet 310 that is provided on one side or on both sides of a lower portion, and an opening and closing door 330 that is provided to open and close the combustion air inlet 310. FIG. 3 and FIG. 5 specifically illustrate a form of the combustion air inlet 310 formed at the lower portion of the outer case.

In the embodiment according to the accompanying drawings, it can be seen that two or more combustion air inlets 310 are formed, the opening and closing door 330 is also provided with a plurality of holes corresponding to the combustion gas inlets, and a guide portion 340 which can be slid left and right in a state of supporting the opening and closing door 330 may be further provided.

However, the combustion air inlets and the opening and closing door may be formed in various types, and the guide portion may be formed in a different type or be omitted according to the type of the opening and closing door.

Referring to accompanying FIG. 3 and FIG. 5, the opening and closing door 330 may be punched with one or more holes 331, and can adjust an air inflow rate by adjusting the open and close width while linearly moving along the guide portion 340 longitudinally provided in the horizontal direction, thereby adjusting fire power of the burner.

According to the invention, the outer case 300 provided outside the inner case 200 is provided to surround the fuel tank and the inner case at a regular interval on the outside of the fuel tank 100 and the inner case 200, and the combustion gas exhaust holes B 320 are formed at a position corresponding to the combustion gas exhaust holes A 220 provided on the inner case 200.

The heat-resistant insulation material 400 is provided in a space formed between the inner case 200 and the outer case 300 to block a phenomenon of directly transferring the heat from the inner case 200 to the outer case 300 and to prevent a user from being burned by the heat of the inner case.

In addition, a heat-resistant fuel tank insulation material 410 is provided on the fuel tank 100, and a plurality of supports 430 are provided to form a spatial portion 420 blocking the conducted heat and serving as a passage of the combustion air between the fuel tank insulation material 410 and the block plate 230. Accordingly, when the flame of the burner according to the invention is burned in a combustion space formed between the inside of the inner case 200 and the bottom of the camping cooker 500 to emit thermal energy, the thermal energy is not directly transferred to the fuel tank 100, and thus it is possible to prevent explosion and fire.

The camping cooker 500 inserted into the inner case 200 is inserted into the burner through the camping cooker input port 350, thereby being inserted into the inner case 200, and includes a lid 510 that opens and closes the upper portion and a handle 520.

The handle 520 is put in a folded state on the lid 510 at the time of carrying and keeping similarly to the normal camping cooker, and is kept in an unfolded state at the time of cooking, to prevent it from being heated by the heat, and the camping cooker 500 can be easily lifted and carried.

Meanwhile, in a state where any one end is embedded in the fuel tank 100 and the other end protrudes upward, the wick 111 which is ignited at the end protruding upward is wove with asbestos or materials similar thereto, the fuel contained in the fuel tank 100 is raised and burned by a capillary phenomenon, and the wick 111 is inserted into the rectangular wick tube 110, is supported inside by the rectangular wick center support 112, and is fixed with the rectangular shape kept.

An ignition check window B 360 and an ignition check window A 250 formed to mutually coincide with the outer case 300 and the inner case 200 are provided to check ignition in the combustion chamber, and preferably, is made of heat-resistant transparent glass or transparent synthetic resin.

A fuel injection port 380 provided at the lower end portion of the outer case 300 is opened and closed by a fuel injection port lid 381, and is provide to supplement and inject the fuel in connection with the fuel tank 100.

Reference numeral 370 which is not described denotes an ignition button provided to ignite the wick 111, and can be operated using an ignition device of a general piezoelectric element ignition type.

FIG. 5 is a perspective view illustrating a state where the portable burner according to the invention is also usable as a heater, the embodiment illustrated in FIG. 5 is characterized in that a heater lid 390 to cover the camping cooker input port 350 formed at the upper portion of the outer case 300 is additionally provided. According to the embodiment illustrated in FIG. 5, it can be seen that the heater lid 390 further includes a coupling wing 391 to be fitted and coupled with the upper edge of the outer case 300, and a plurality of exhaust holes 392 are formed on the upper face as necessary.

However, the heater lid is formed corresponding to the shape of the outer case to prevent the heat generated therein from being rapidly discharged to the outside or to prevent the inner flame from transferring to a flammable material, the exhaust holes 392 may not be particularly formed on the heater lid, and means for opening and closing the exhaust holes is further provided even when the exhaust holes are provided, thereby opening and closing the exhaust holes as necessary.

According to the invention, even when the heater lid is not provided with the exhaust holes, it is obvious that the exhaust and/or heater function can be provided by the combustion gas exhaust holes B 320 provided on the side of the external case 300.

FIG. 6 is a cross-sectional view illustrating an operation state of the portable burner according to the invention, and when the camping cooker 500 in which ingredients of food to cook are contained are mounted in the burner and ignition is performed, the combustion gas is raised in zigzag left and right through the exhaust pipe 240 formed by the multistep combustion gas guide wall 210 having the multi-layer structure and the exhaust pass holes 211 formed thereon and transfers the heat to the bottom and the side of the camping cooker 500 as illustrated in arrows of the drawing. Accordingly, through the course of evenly transferring the heat to the bottom and the side of the camping cooker 500, the ingredients remaining therein can be rapidly and completely cooked, and it helps to have a meal for a long time since the food is not easily cooled even after cooking.

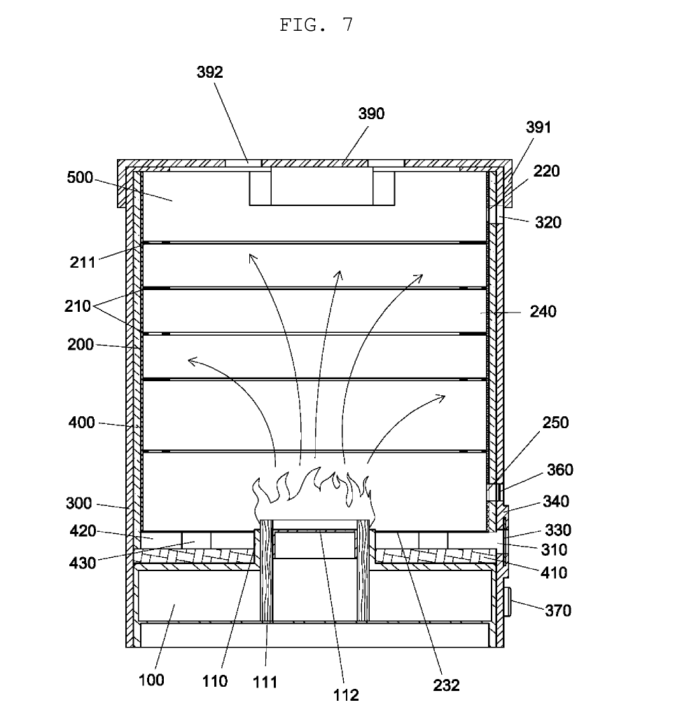

In addition, according to the invention, the outer case is provided separately from the inner case, it is safe from the risk of a burn or fire, and when the heater lid is provided at the upper portion to emit the heat to the upside, it serves as an easily portable simple heater. FIG. 7 is a cross-sectional view illustrating an operation state of using the portable burner according to the invention as the simple heater, and illustrates that the heater lid 390 is covered and coupled on the outer case 300 in a state where the camping cooker 500 is removed, ignition is performed, and thus it can be used as the heater. The coupling wing 391 of the heater lid 390 is coupled with the upper edge of the outer case 300 so as not to easily deviate, thereby further safely using it.

According to the invention, the burner and the camping cooker can be integrated, the camping cooker can be completely inserted and installed into the burner, it is possible to minimize the volume according to separately providing the camping cooker and the burner in the related art, and thus keeping and carrying are easy.

According to the invention, the burner and the camping cooker can be unitized and the camping cooker can be completely inserted into the burner, so that the volume can be minimized unlike the conventional camping cooker and burner, which are separately formed, thereby facilitating the carrying and storage thereof.

Also, the adiabatic function is added in the space formed between the outer case and the inner case, so that the loss of the heat emitted to outside can be minimized and the danger of the image due to heat can be prevented; since there is no ignition possibility through the inside and outside closure structure even in the nearing of the inflammable material, it can be used without the danger of fire; and the heating is transferred throughout the bottom surface and the external surface of the camping cooker during the cooking of rice in the high mountain or the outside, so that it can prevent the multi-layered rice and the cooking is easily and quickly.

The preferred embodiments of the invention have been described above, but the scope of rights of the invention is not limited thereto, it should be understood that the scope of rights of the invention also includes the scope substantially equivalent to the embodiments of the invention, and the invention may be variously modified by a person skilled in the art to which the invention belongs within the scope which does not deviate from the spirit of the invention.

What is claimed is:

1. A portable burner comprising:
a fuel tank that is provided with a wick tube thereon and into which liquid fuel is injected;
an inner case that is provided above the fuel tack and is integrally provided with a combustion gas guide wall having a multi-layer structure on an inner peripheral face; and
an outer case that is provided to surround at a regular interval on the outside of the fuel tack and the inner case.

2. The portable burner according to claim 1, further comprising a camping cooker that is inserted into the inner case.

3. The portable burner according to claim 2, wherein the combustion gas guide wall comes in close contact with an outer side of the camping cooker inserted into the inner case to form an exhaust pipe, and the exhaust pipe is formed in zigzag.

4. The portable burner according to claim 1, wherein the outer case comprises:
a camping cooker input port that is formed in a state where an upper portion is opened to insert and mount the camping cooker;
a combustion air inlet that is provided at a lower portion; and
an opening and closing door that opens and closes the combustion air inlet.

5. The portable burner according to claim 1, wherein the inner case is provided with a block plate on the bottom thereof, the block plate is punched with a wick tube hole for fitting and coupling the wick tube of the fuel tank, and a plurality of air inflow holes are formed around the wick tube hole.

6. The portable burner according to claim 5, wherein a heat-resistant fuel tank insulation material is provided on the fuel tank, and a support is provided to form a spatial portion serving as a conducted heat blocking function and combustion air passage function between the fuel tank insulation material and the block plate.

7. The portable burner according to claim 1, further comprising a heater lid for covering the camping cooker input port, on the outer case.
